(19) United States
(12) Patent Application Publication
(10) Pub. No.: US 2007/0206650 A1
(43) Pub. Date: Sep. 6, 2007

(54) Optical Sensor Using a Laser Mounted on Top of a Semiconductor Die

(76) Inventors: Karthik Ranganathan, Santa Clara, CA (US); Gary Gibbs, San Jose, CA (US); Carlo Gamboa, Milpitas, CA (US)

Correspondence Address: Michael T. Moore;Cypress Semiconductor Corp., Legal Group, 198 Champion Court, San Jose, CA, 95134, US

(21) Appl. No.: 11/682,161

(22) Filed: Mar. 5, 2007

Related U.S. Application Data
(60) Provisional application No. 60/779,701, filed on Mar. 6, 2006.

(51) Int. Cl. H01S 3/00

(52) U.S. Cl. 372/38.05

(57) ABSTRACT

A semiconductor device comprising an integrated circuit die and an electronic component mounted to the integrated circuit dies wherein the electronic component comprises a light emitting active area arranged to emit light.

### CROSS-REFERENCE TO RELATED APPLICATIONS

The present application claims the benefit of priority under 35 U.S.C. 119(e) to U.S. Provisional Patent Application Ser. No. 60/779,701., entitled Mouse Sensor Using a VCSEL Mounted on Top of a Silicon Die; which application is hereby incorporated by reference.

### TECHNICAL FIELD

This invention relates to a semiconductor device, in particular to a semiconductor device provided with an integrated circuit die and an electronic component, for example a vertical-cavity surface-emitting laser and a method of assembling such a semiconductor device.

### BACKGROUND

A vertical-cavity surface-emitting laser (VCSEL) is a type of semiconductor laser that emits laser light vertically from the surface of a chip. Conventionally, a VCSEL includes an active area disposed or sandwiched between a first contact, sometimes called a laser anlode, and a second contact. During operation, a voltage is applied across the electrical contacts generating a current through the VCSEL, and thus causing emission of light.

Because VCSELs can be driven at high speeds and at low power levels, VCSELs are widely used as a light source for a variety of applications in optical fiber data transmission, analog broadband signal transmission, absorption spectroscopy, computer peripheral devices and related applications. The optical output power of the VCSEL is determined by the amount of current driven through the VCSEL. In some applications, such as bar-code readers, digital video discs (DVDs) and compact discs (CDs), it is highly desirable to maintain a fixed optical output power.

A conventional embodiment of a VCSEL package is described, wherein the conventional VCSEL package comprises a substrate and a VCSEL device coupled to the substrate. The VCSEL needs to be calibrated in order to provide a correct optical output. One way of achieving this calibration is to use a semiconductor device comprising of a sensor circuit or a calibration VCSEL. A sensor circuit is coupled to the substrate such that a sensor area of the sensor is aligned with the VCSEL. The sensor measures light intensity from the VCSEL to determine the power output of light. The value of the measured light intensity is subsequently used to adjust the electrical power input to the VCSEL device to maintain the power output of the light emitted from the VCSEL at a fixed value.

A disadvantage of this conventional solution is that all the VCSEL pins need to be at least half etched to minimize electrostatic discharge structure (ESD) exposure.

The conventional VCSELs are typically based on gallium arsenide (GaAs) wafers with Bragg mirrors formed from Ga s and aluminium gallium arsenide (AlₓGa₍₁₋ₓ₎As). The GaAs/AlGaAs system is favored for constructing VCSELs because lattice constants of the material do not vary as the composition is changed, permitting multiple lattice matched epitaxial layers to be grown on the GaAs substrate. However, the refractive index of AIGaAs does vary as the fraction of Al in AlGaAs is increased, thereby minimizing the number of layers required to form an efficient Bragg mirror. Furthermore, the concentration of Al is critical to form an oxide from AlGaAs, which restricts the flow of current in the VCSEL. For example, high concentrations of Al enable for relatively low threshold currents in the VCSEL.

The conventional VCSEL solution has the disadvantages of high manufacturing cost, lack of repeatability, large chip area and poor quality control, thus limiting high-volume manufacturing.

It would therefore be desirable to have a semiconductor device comprising a VCSEL that is less expensive to manufacture and has higher reliability.

### BRIEF DESCRIPTION OF THE DRAWINGS

Aspects of the present inventions will become apparent from and will be elucidated with respect to the embodiments described hereinafter with reference to the accompanying drawings. The drawings illustrate the embodiments of the invention and together with the description, serve to explain the principles of the invention. In the drawings:

FIG. 1 illustrates a schematic representation of a semiconductor device;

FIG. 2 illustrates another schematic representation of a semiconductor device; and

FIG. 3 shows a schematic representation of a system comprising the semiconductor device.

### DETAILED DESCRIPTION

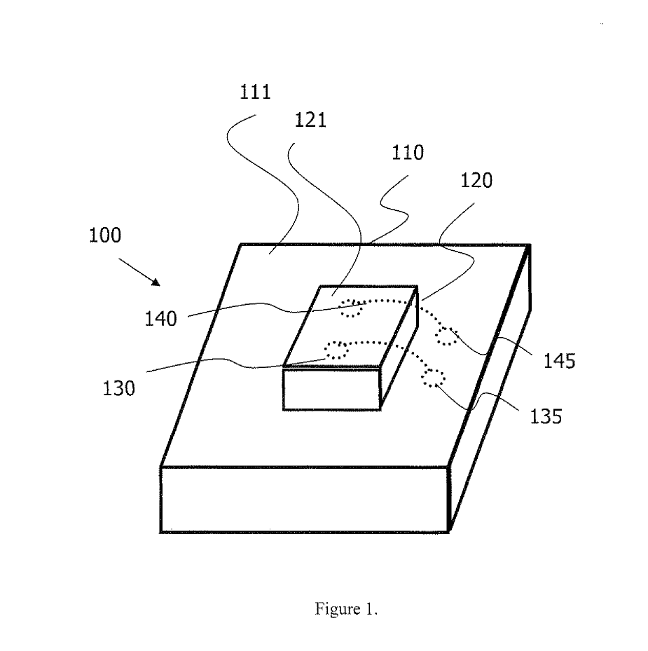

According to the first embodiment, the present invention provides an improved semiconductor device 100 comprising an integrated circuit die 110, hereinafter also referred to a silicon die, and an electronic component 120 mounted to the integrated circuit die 110, wherein said electronic component 120 comprises an active area, wherein said active region is a light emitting active region as shown schematically in FIG. 1.

The semiconductor device 100 comprises an integrated circuit die 110 and the electronic component 120 with a light emitting active region, for example a vertical-cavity surface-emitting laser (VCSFL) or a laser diode, mounted on the integrated circuit die 110. The VCSEL 120 additionally comprises a sensor circuit (not shown in the FIG. 1) to calibrate the VCSEL 120 in order to provide a correct optical output. The power of the light emitted from the VCSEL 120 is generally maintained at a fixed value. This can be achieved by an additional circuitry (not shown in FIG. 1) attached to the semiconductor device 100.

The VCSEL 120 is mounted onto the integrated circuit die 110 by means of mounting joints (not shown in FIG. 1) for example a solder. Other methods of mounting the VCSEL 120 on the integrated circuit die 110 include bonding using glue or other adhesives. For example, mounting the electronic component 120 onto the integrated circuit die 110 is typically done by means of aligning the electronic component 120 onto the integrated chip die 110 and soldering the joints. An alternative method of mounting the electronic component 120 onto the integrated circuit die 110 would be to bond the components, namely the electronic component 120 and the integrated circuit die with a conducting bonding agent, for example an adhesive. It should be apparent to a skilled person that other mounting techniques know in the t could be used to mount the electronic component 120 onto the integrated circuit die 110 and fall thin the scope of the present invention.

An advantage of mounting the electronic component 120 on the integrated circuit die 110 is that the size of the integrated circuit die 110 is reduced, resulting in lower cost of manufacturing the semiconductor device 100. A further advantage is that mounting the VCSEL 120 aids in precise die tilt control during the assembly process as compared to use of leadframes, thereby improving the quality of the semiconductor device 100. Further, the integration of the VCSFL 120 on the integrated circuit die 110 offers an improvement in terms of density, bandwidth and power consumption.

In a further embodiment, the electronic component 120 comprises an anode 140 and a cathode 130 respectively. The anode 140 and cathode 130 are provided as pads on the VCSEL 120. The anode 140 and cathode 130 are provided on the upper surface 121 of the VCSEL 120. This is achieved by bonding the anode 140 and the cathode 130 using a suitable bonding agent for example glue, and the bonding agent being conductive.

An advantage with the arrangements of the anode 140 and cathode 130 being provided on the upper surface 121 of the electronic component 120 is that the number of connector pins is reduced. This results in a further reduction of manufacturing cost and simplicity of manufacturing the semiconductor device.

The cathode 130 on the upper surface 121 of the VCSEL 120 is connected to a cathode connector 115 on the upper surface 111 of the integrated circuit 110 via a wire bond. Similarly, an anode 140 on the upper surface 121 of the VCSEL 120 is connected to an anode connector 145 on the upper surface 111 of the integrated circuit 145 via a wire bond. Advantageously, the wire bonds connecting the anode and cathode to respective anode connector and cathode connector are preferably made of a similar material in order to avoid excessive heating and losses of an electrical signal, for example supply current and/or voltage, supplied to drive the electronic component. By controlling the electrical signal the power or intensity of the light emitted from the electronic component 120 can be suitably controlled.

The wire bonds connecting the anode 140 and cathode 130 to the respective connectors 145 and 135 are chosen from a set of conducting materials that are similar to the material used to form the anode 140 and cathode 145. An advantage of using similar material is for the wire bonds and the anode 140 and/or the cathode 130 is of improved conductivity as compared to using dissimilar material, which leads to electrical losses because of the different material constants. A further advantage is that the number of electrical connector pins is reduced.

Generally, the VCSEL 120 includes at least one ground pad (not shown in FIG. 1), which is associated with ground voltage. During use, the ground pad is electrically connected to a reference voltage source, for example ground, thus maintaining the ground at a common potential. The ground forms the first contact for the VCSEL 120 and the bond pads, the cathode and the anode, form the second contact for the VCSEL 120.

In a further embodiment, the integrated circuit die 110, the electronic component 120 and the wire bonds that connect the electronic component 120 to the integrated circuit die 110 are encapsulated within a mold of a transparent material. Preferably clear thermoset materials such as epoxy resins, plastics and the likes are used for molding the integrated circuit die 110 and the electronic component 120 into a single package. The molding provides protection to the semiconductor device 100 and also prevents the wire bonds from being accidentally disconnected. A further advantage of the single package semiconductor device 100 is that the individual components forming the semiconductor device 100 have a higher stability, and accidental breakage of the semiconductor device 100 or of the individual components of the semiconductor device 100 is prevented.

In a further embodiment, the integrated circuit die 110, the wire bonds and the electronic component 120 are provided, for example coated, with a layer of a compliant material.

The layer of compliant material, for example silicones, gel or the likes, on the integrated circuit die 110 and the electronic component 120 provides a stress buffer to these components. During operation, for example when a voltage is supplied to the semiconductor device 100, the various components of the semiconductor device 100 get heated, leading to a mechanical stress or thermal stress being created in the materials forming the various components of the semiconductor device 100. This mechanical stress or the thermal stress can damage or dislodge the components of the semiconductor device 100. For example, thermal stress arises due to the different coefficients of thermal expansion of the materials, which can damage the components of the semiconductor device 100, and the use of a layer of compliant material reduces the thermal stress on the components and improves reliability.

In an alternative embodiment, the semiconductor device 100 comprising the electronic component 120 can be formed as a leadless chip carrier package. Other electrically conductive modifications known to those skilled in the art may be used, and are covered under the scope of this invention.

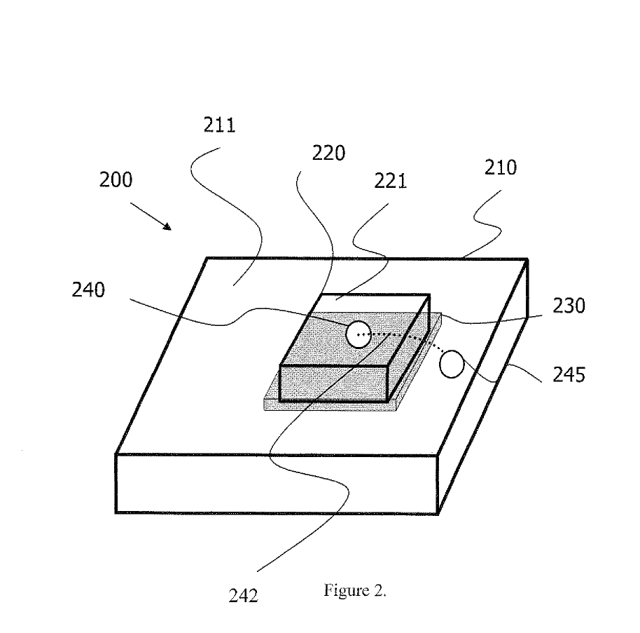

FIG. 2 shows another schematic representation of a semiconductor device 200 in accordance with the present invention. The functioning of the semiconductor device 200 is similar to the functioning of the semiconductor device 100 described previously in FIG. 1. However, there exists a structural difference between the mounting of the electronic component 220 as compared to the electronic component 120.

In a further embodiment schematically shown in FIG. 2, the anode 240 is provided on the upper surface 221 of the electronic component 220. The cathode 230 is provided as an electrically conducting material mounted between the upper surface 211 of the integrated circuit die 210 and the base of the electronic component 220. The base of the electronic component 220 is positioned opposite to the upper surface 221. An advantage is that the number of connector pins is reduced and thus results in lowering manufacturing cost and simplicity of manufacturing the semiconductor device 200.

The anode 240 on the upper surface 221 of the VCSEL 220 is connected to an anode connector 245 positioned on the upper surface 211 of the integrated circuit die 210. The cathode 230 is provided as a layer between the base of the electronic component 220 and the upper surface 211 of the integrated circuit die 210. Using a conductive bonding material, for example an epoxy or the likes, the cathode 230 is bonded to the upper layer 211 of the integrated circuit die 210. An advantage of this method is the freedom provided in designing the semiconductor device 200. It should be apparent to a skilled person that various other modifications of the said semiconductor devices are possible and are covered within the scope of this invention.

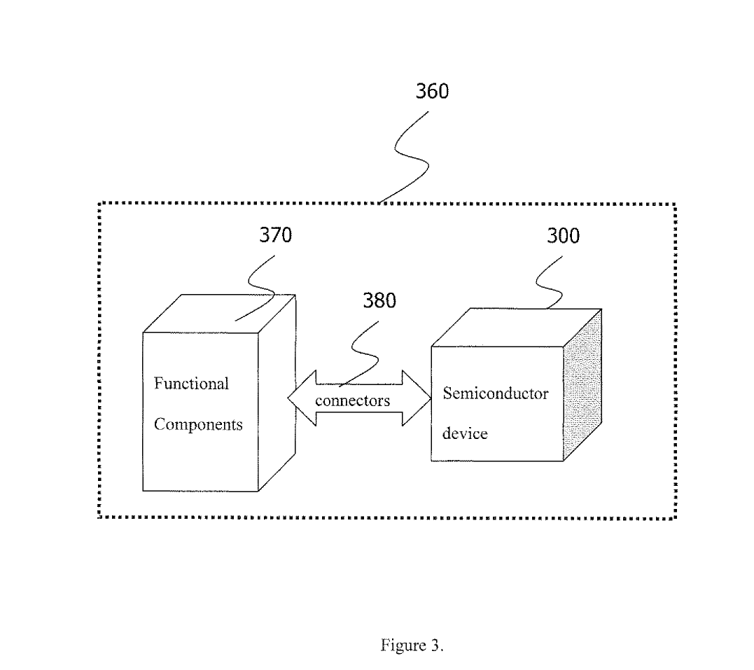

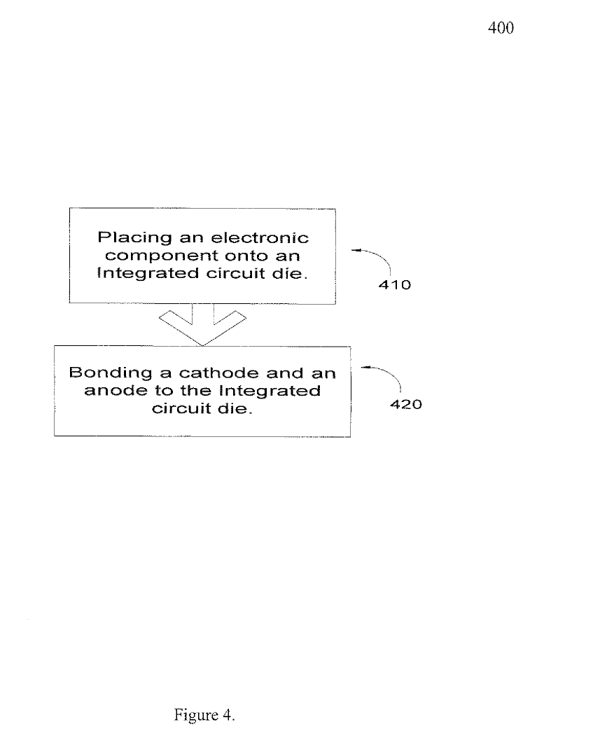

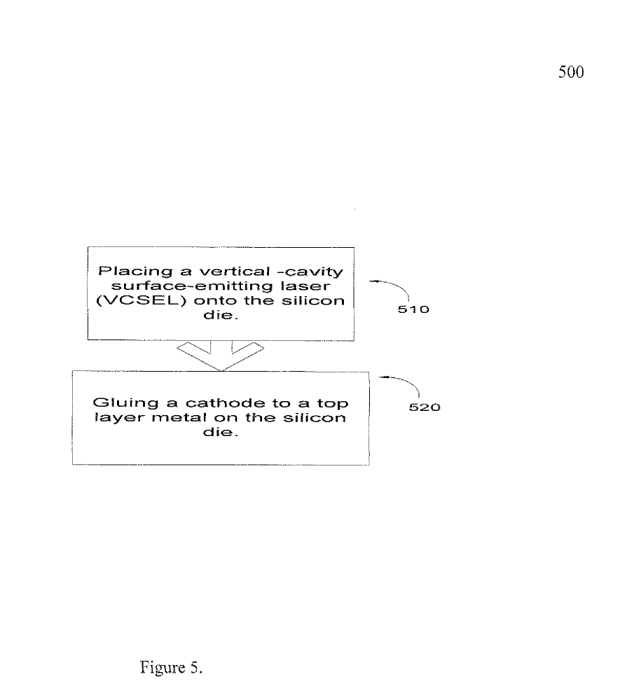

In a further embodiment as shown in FIG. 3, a system 360, for example a mouse, a bar code reader and the likes, comprises a semiconductor device 300, the semiconductor device further comprising an integrated circuit die and an electronic component mounted on the integrated circuit die wherein said electronic component comprises a light emitting active region.. Other features and operational details of the semiconductor device 300 of the system 360 have been described previously with respect to FIG. 1 and FIG. 2. The system, for example an information acquisition device or a human interface device, comprises various other functional components 370 which are not within the scope of this invention. However for the system 360 to function as a single unit, the functional components 370 are coupled via connectors 380 to the semiconductor device 300. For example, the system includes reading devices for example information acquisition devices such as a bar-code reader or a human interface device or a sensing device such as an optical navigation system. The information acquisition device is an advantageous laser source of choice for high-speed fiber optics, optical encoders, optical read/write, and many other applications.

One skilled in the art easily recognizes that either one of the semiconductor devices 100, 200 may be used within a system 360. Such a system 360 may be advantageously used as a sensor.

Reference is made back to FIG. 1, wherein a further embodiment describes a method of assembling the semiconductor device 100. The method comprises a first step of mounting an electronic component 120, for example a VCSEL, on an integrated circuit 110. The method comprises a second step of coupling an anode 140 and a cathode 130 on the electronic component 120 to a respective anode connector 145 and cathode connector 135 on the integrated circuit die 110 via respective wire bonds. The method comprises a third step of encapsulating the integrated circuit die 110 and the electronic component 120 with a transparent material, for example thermoset materials as described previously.

In yet a further embodiment, the method of assembling the semiconductor device 100 comprises encapsulating the integrated circuit 110 and the electronic component 120 with a layer of a compliant material immediately prior to the step of molding the integrated circuit and the electronic component.

Reference is made back to FIG. 2, wherein a further embodiment describes a method of assembling the semiconductor device 200 comprising mounting an electrically conductive material on at least a part of the upper surface 211 forming the cathode 230, next mounting an electronic component 220, for example a VCSEL, on a cathode by bonding the cathode with the base of the electronic component 120, next coupling an anode pad 140 on the electronic component 120 to a respective anode connector 245 on the integrated circuit die 210 via respective wire bonds 242, and next encapsulating the integrated circuit die 110 and the electronic component 120 with a transparent material, for example thermoset materials as described previously.

In yet a further embodiment, the method of assembling the semiconductor device 200 comprises encapsulating the integrated circuit 210 and the electronic component 220 with a layer of a compliant material immediately prior to the step of molding the integrated circuit and the electronic component.

In a further embodiment, a system comprising a semiconductor device 100 further comprises a means for emitting light from an electronic component 120 mounted on an integrated circuit die 110 on application of a voltage pulse. The semiconductor device 100 further comprises a means for detecting, for example a detector such as a photodiode or the likes, the reflection of the emitted light from a reflecting surface (not shown in the Figure). The system further comprising means for detecting the reflected light is mounted on alongside the VCSEL 120. Advantageously, the detector surface can surround the VCSEL 120. The light beam emitted from the VCSEL 120 diverges on leaving the semiconductor device 100, and reflects from the reflecting surface before being detected by a detector.

FIG. 4 shows an embodiment of the present invention, wherein a flow chart 400 describes a method of mounting a device on a base. A first step 410 comprises placing an electronic component onto an integrated circuit die, wherein the electronic component comprises a light emitting active region. A second step 420 comprises bonding a cathode and an anode to the integrated circuit die, wherein the cathode and the anode are both pads on a top layer of the electronic component. The electronic component is a vertical-cavity surface-emitting laser (VCSEL). Both the cathode pad and the anode pad are wire bonded to the integrated circuit die. The electronic component is glued to both the cathode pad and the anode pad.

FIG. 5 shows an embodiment of the present invention, wherein a flow chart 500 describes a method of mounting an electronic component on a silicon die. A first step 510 comprises placing a vertical-cavity surface-emitting laser (VCSEL) onto the silicon die, wherein the VCSEL component comprises a light emitting active region. A second step 520 comprises gluing a cathode to a top layer metal on the silicon die, wherein the cathode is present on the base of the VCSEL and the anode is a pad on the VCSEL. The cathode is glued to the top layer metal on the silicon die by a conductive die attach material.

A first advantage of the semiconductor device assembled according to the present invention is that it occupies a lesser area than the prior art devices. A second advantage is that to assemble the semiconductor device an easy to use molding technology over the package is applied. The semiconductor device has a better die tilt control, the VCSEL is mounted on silicon, which is of the order of 29 mils in an exemplary embodiment. The VCSEL need not be half etched for ESD protection. They just need to be bonded to the analog die. The overall cost of the semiconductor device reduces due to lower size and lower package pin count.

It is understood that while the embodiments set forth herein have been described in detail, it should be understood that the present invention could be subject to various changes, substitutions, and alterations without departing from the spirit and scope of the invention. For purposes of clarity, many of the details of the improved semiconductor device and the methods of designing and manufacturing the same that are widely known and are not relevant to the present invention have been omitted from the following description.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

What is claimed is:

1. A semiconductor device, comprising:
an integrated circuit die; and
an electronic component mounted to the integrated circuit die, the electronic component comprising a light emitting active region.

2. The semiconductor device of claim 1, wherein the electronic component is a vertical-cavity surface-emitting laser (VCSEL).

3. The semiconductor device of claim 1, wherein the electronic component comprises an anode and a cathode.

4. The semiconductor device of claim 3, wherein the anode and the cathode are electrically coupled to an anode connector and a cathode connector respectively on the integrated circuit die via wire bonds.

5. The semiconductor device of claim 4, wherein the anode is electrically coupled to the anode connector on the integrated circuit die via a wire bond, and the cathode is mounted on at least a part of the integrated circuit die and electrically coupled to the electronic component via a conductive bonding agent.

6. The semiconductor device of claim 3, wherein the integrated circuit die, the electronic component, the anode, the cathode and the wire bonds are encapsulated with a mold of a clear material.

7. The semiconductor device of claim 1, wherein the integrated circuit die and the electronic component are coated with a layer of a material.

8. A system, comprising:
an integrated circuit die; and
an electronic component mounted to the integrated circuit die, the electronic component comprising a light emitting active region

9. The system of claim 8, wherein the electronic component comprises a laser diode.

10. The system of claim 8, comprising a means for emitting light from the light emitting active region of the electronic component.

11. The system of claim 8, further comprising a means for detecting a reflection of light reflected from a surface.

12. A method of assembling a semiconductor device, the method comprising:
mounting an electronic component onto an integrated circuit die, wherein the electronic component comprises a light emitting active region;
coupling an anode and a cathode to a respective anode connector and a cathode connector via wire bonds, wherein both the anode connector and cathode connector are located on the integrated circuit die; and
encapsulating the integrated circuit die and the electronic component with a mold of a transparent material.

13. The method of claim 12, further comprising mounting the cathode on the integrated circuit die.

14. The method claim 12, further comprising encapsulating the integrated circuit die and the electronic component with a layer of a compliant material.

15. A method of mounting a device on a base, the method comprising:
placing an electronic component onto an integrated circuit die, wherein the electronic component comprises a light emitting active region; and
bonding a cathode and an anode to the integrated circuit die.

16. The method of claim 15, wherein the cathode and the anode are both pads on a top layer of the electronic component.

17. The method of claim 15, wherein the electronic component is a vertical-cavity surface-emitting laser (VCSEL).

18. The method of claim 15, wherein both the cathode pad and the anode pad are wire bonded to the integrated circuit die.

19. The method of claim 15 wherein the electronic component is glued to both the cathode pad and the anode pad.

20. The method of claim 15, further comprising:
placing a vertical-cavity surface-emitting laser (VCSEL) onto the silicon die, wherein the VCSEL component comprises a light emitting active region;
gluing a cathode to a top layer metal on the silicon die, wherein the cathode is present on the base of the VCSEL and the anode is a pad on the VCSEL.

21. The method of claim 20, wherein the cathode is glued to the top layer metal on the silicon die by a conductive die attach material
